(19) United States
(12) Patent Application Publication
(10) Pub. No.: US 2012/0326683 A1
(43) Pub. Date: Dec. 27, 2012

(54) EQUALIZATION OF THE CURRENT IN A THREE-PHASE ELECTRICAL POWER SYSTEM

(76) Inventor: Noel Johnson, Sonora, CA (US)

(21) Appl. No.: 13/397,066

(22) Filed: Feb. 15, 2012

Related U.S. Application Data
(60) Provisional application No. 61/500,533, filed on Jun. 23, 2011.

(51) Int. Cl. G05F 1/12

(52) U.S. Cl. 323/282

(57) ABSTRACT

This is directed to systems, processes, machines, and other means that enable automatic shifting of current loads in a three phase power system. The invention can rapidly shift power phases to various loads such that each phase could power each load, resulting in equalizing the average current in each power phase.

### CROSS REFERENCE TO RELATED APPLICATIONS

This application claims priority to U.S. Provisional Patent Application No. 61/500,533 filed Jun. 23, 2011.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION BY REFERENCE OF MATERIAL SUBMITTED ON A COMPACT DISC

Not Applicable

### FIELD OF THE INVENTION

This invention relates to utilizing three-phase power more efficiently by balancing the loads on each of the three phases.

### BACKGROUND OF THE INVENTION

The advantages of a balanced three-phase power system comprising balanced three-phase sources and a balanced three-phase load when compared to a single-phase system are well known. As Kumar explains in Electric Circuits and Networks: first, power loss in a transmission system is lower in a three-phase system. Second, copper utilization is less in a three-phase system. Third, electrical components designed for three-phase operation are more efficient than their single-phase counterparts. However, when the loads are unbalanced, the three-phase system suffers from pulsation and substantial system inefficiency.

Current solutions to this problem partially resolve the matter and are insufficient. As indicated below, other systems shift one-phase loads, try to mitigate the system pulsation, or adjust the neutral current.

### BACKGROUND ART

The Cheng U.S. Pat. App. No. 2010/0033154A1 teaches a power converter with a constant time control for use in single phase switching regulators. The current invention applies to power lines using three phase power and not pulse width modulators.

The Carpenter U.S. Pat. No. 7,903,433 teaches a power converter that transfers some current load between power phases in a circuit. The current invention uses a series of relays to transfer power phases to different loads entirely, rather than partially.

The Kim U.S. Pat. No. 7,732,940 teaches load switching as a means for reducing neutral current in a three phase circuit. However, it does not teach a method for rotating power phases to loads in a three phase power system.

### BRIEF SUMMARY OF THE INVENTION

Methods, systems, and other means are provided for balancing the loads on each phase of a three-phase power system. In accordance with some embodiments,

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is an explanatory illustration of the first portion of the circuit layout.

FIG. 2 is an explanatory illustration of the second portion of the circuit layout.

FIG. 3 is an explanatory illustration of the third portion of the circuit layout.

### DETAILED DESCRIPTION OF THE INVENTION

Embodiments of the present invention overcome many of the obstacles associated with electrical system with a three phase power source and a three phase load, and now will be described more fully hereinafter with reference to the accompanying drawings that show some, but not all embodiments of the claimed inventions. Indeed, the machine may be embodied in many different forms and should not be construed as limited to the embodiments set forth herein. Rather, these embodiments are provided so that this disclosure will satisfy applicable legal requirements. Like reference characters refer to like elements throughout.

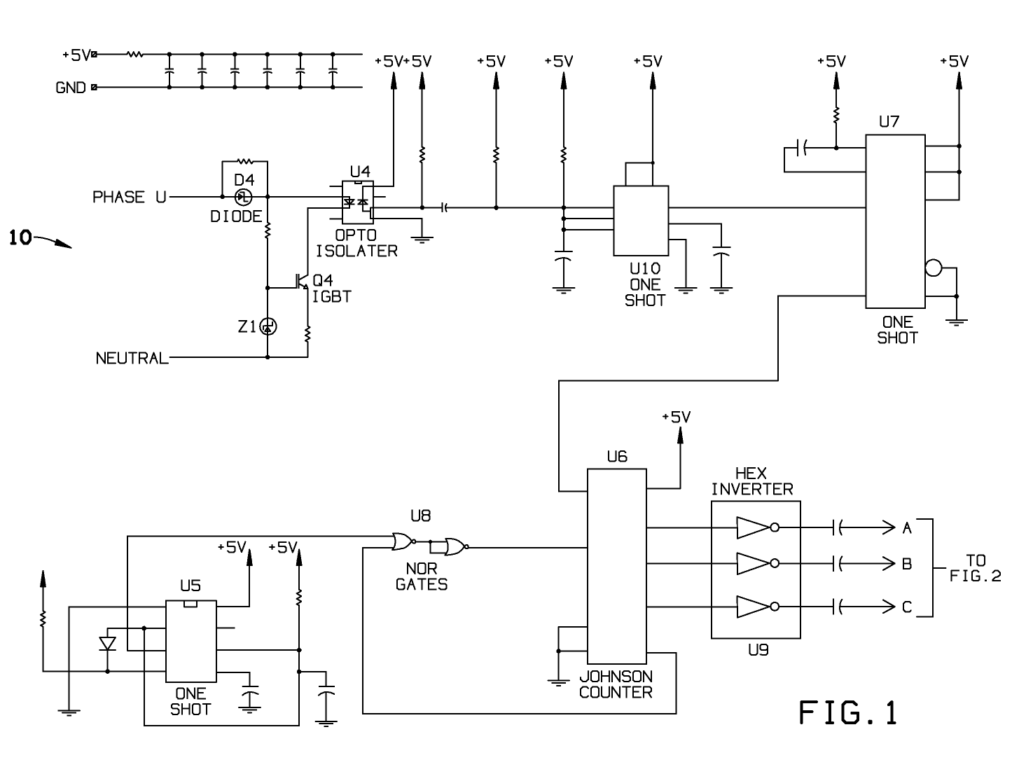

FIG. 1 shows the timing portion of equalization circuit 10. Phase U is electrically coupled to a neutral through a zero-cross detector. The zero-cross detector comprises Diode D4, Opto isolater U4 and Insulated Gate Bipolar Transistor (“IGBT”) Q4 and zener diode Z1. Opto isolater U4 is an electronic device designed to transfer electrical signals by utilizing light waves to provide coupling with electrical isolation between its input and output. Opto isolator U4 prevents high voltages or rapidly changing voltages on one side of the circuit from damaging components or distorting transmissions on the other side.

One shot U5 creates an initial pulse at startup which resets Johnson counter U6 to Zero. After the device is in operation, phase U travels through the zero-cross detector. One shot U10 shapes the pulse width which then travels to one shot U7. One shot U7 reshapes the pulse width which then travels to Johnson Counter U6. Johnson Counter U6 creates first enabling output A, second enabling output B and third enabling output C in a cycle based on the setting of the timer in Johnson Counter U6. In this embodiment, Johnson Counter U6 is a timing mechanism.

Johnson counter U6 is electrically coupled to quad-NOR logic device U8. Quad-NOR logic device U8 resets Johnson counter U6 to zero at an interval determined by a user setting and at startup from one shot U5 as explained above. When zero cross detector Z1 detects zero phase voltage zero cross detector Z1 emits an electronic pulse to Johnson counter U6 as the AC voltage goes through zero volts. Johnson counter U6 counts the number of AC voltage cycles and provides one of: first enabling output A, second enabling output B or third enabling output C every ‘n’ cycles. Here, ‘n’ is a setting chosen by the user by calibrating Johnson counter U6 and quad-NOR logic device U8. Here, ‘n’ can be any number of cycles greater than or equal to 3, for instance to balance every second, ‘n’ would be 20.

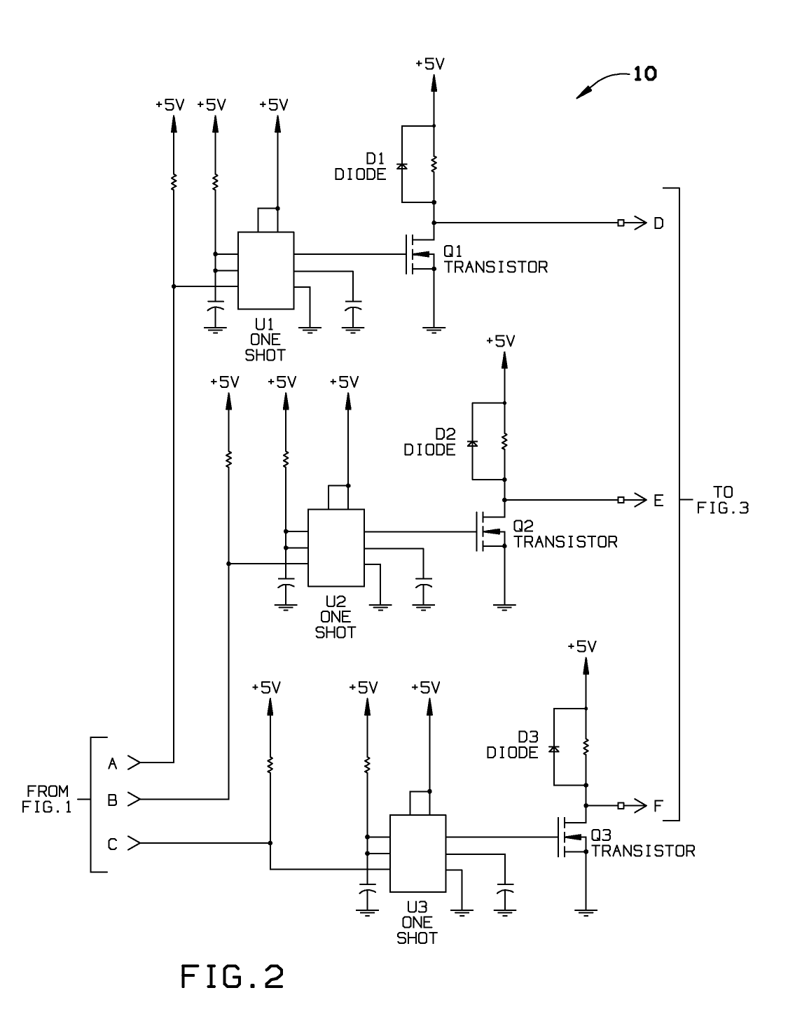

Hex inverter U9 is a logic device that takes either first enabling output A, second enabling output B or third enabling output C and inverts each output from Johnson counter U6. After being inverted by hex inverter U9, first enabling output A, second enabling output B or third enabling output C travels to a bank of switches as shown in FIG. 2.

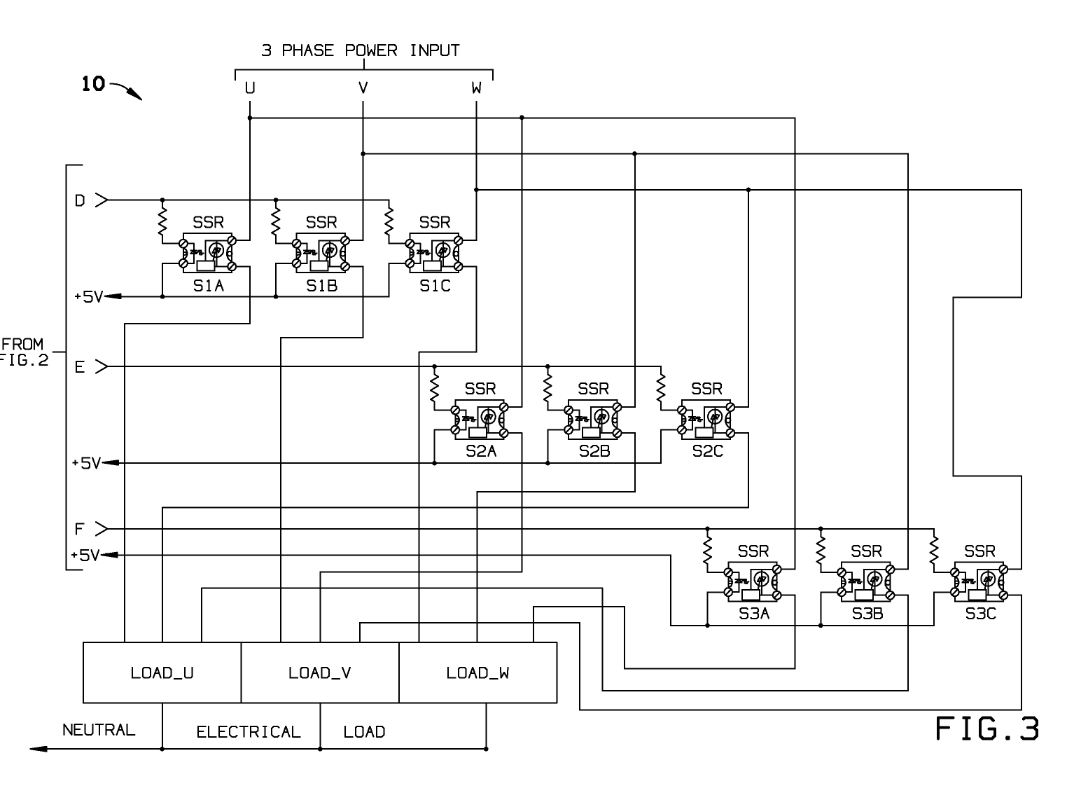

FIG. 2 shows a plurality of one shot multivibrators in equalization circuit 10 which form a switching mechanism. First enabling output A activates one shot multivibrator U1, which travels through transistor Q1 which amplifies first enabling output A to create to first enabling output D. Second enabling output B activates one shot multivibrator U2, which travels through transistor Q2 which amplifies second enabling output B to create second enabling output E. Third enabling output C activates one shot multivibrator U3, which travels through transistor Q3 which amplifies third enabling output C to create third enabling output F. One shot multivibrator U1, one shot multivibrator U2 and one shot multivibrator U3 provide pulsewidth for relay S1A, relay S1B, relay S1C, relay S2A, relay S2B, relay S2C, relay S3A, relay S3B, and relay S3B (collectively, “the relays”) as shown in FIG. 3. The proper pulsewidth for one shot multivibrator U1, one shot multivibrator U2 and one shot multivibrator U3 is that which is necessary to drive the relays.

FIG. 3 shows the connections between the various phases and loads. There are three power phase inputs from a power source: a first power phase—power phase U, a second power phase—power phase V and a third power phase—power phase W. Similarly, there are three loads: a first phase load—load U, a second phase load—load V and a third phase load—load W. First enabling output D is electrically coupled to a first bank of switches: first, from power phase U to relay S1A and then to load U, second from power phase V to relay S1B and then to load V and third from power phase W to relay S1C and then to load W. Second enabling output E is electrically coupled to a second bank of switches: first, from power phase U to relay S2A and then to load V, second from power phase V to relay S2B and then to load W and third from power phase W to relay S2C and then to load U. Third enabling output F is electrically coupled to a third bank of switches: first, from power phase U to relay S3A and then to load W, second from power phase V to relay S3B and then to load U and third from power phase W to relay S3C and then to load V.

The first bank of switches, the second bank of switches and the third bank of switches, may sequentially activate in response to the enabling output from Johnson counter U6 with each one on only one-third of the time. In this manner, power phase U, power phase V and power phase W are rotated among load U, load V and load W.

In some embodiments, during a first cycle, the first bank of switches connects power phase U to load U, power phase V to load V, and power phase W to load W. During a second cycle, the second bank of switches may connect power phase V to load W, power phase W to load U, and power phase U to load V. During a third cycle, Johnson counter U6 may rotate the phases so that the third bank of switches may connect power phase W to load V, power phase U to load W, and power phase V to load U. The cycle may start over and the phases are again rotated to the three loads, thus equalizing the current load of load U, load V and load W among the three incoming power phases U, power phase V, and power phase W during each cycle.

By modifying Johnson counter U6, power phase U, power phase V, and power phase W may be rotated every ‘n’ cycles, where ‘n’ can be a number from 3 to as high as is practical from a power standpoint. For example, if ‘n’ is 20, the phases will rotate every 3*n=60 cycles, or every second in a 60 hertz power system. If ‘n’ is 400, the 3 phases will rotate every 1200 cycles, or every minute, etc. Every third time the phases are rotated, the average current is equalized among power phases U, power phase V, and power phase W.

In one embodiment, the relays may be solid-state relays (SSR's) if the current is relatively low. As used here, a relatively low current is about 100 amperes or less. In this embodiment, relay S1A is a first solid state relay, relay S1B is a second solid state relay, relay S1C is a third solid state relay, relay S2A is a fourth solid state relay, relay S2B is a fifth solid state relay, relay S2C is a sixth solid state relay, relay S3A is a seventh solid state relay, relay S3B is an eighth solid state relay, and relay S3B is a ninth solid state relay.

In another embodiment the relays may be silicon-controlled rectifiers (SCR's) if the current is moderate. As used here, a moderate current is in the hundreds of amperes. In this embodiment, relay S1A is a first silicon-controlled rectifier, relay S1B is a second silicon-controlled rectifier, relay S1C is a third silicon-controlled rectifier, relay S2A is a fourth silicon-controlled rectifier, relay S2B is a fifth silicon-controlled rectifier, relay S2C is a sixth silicon-controlled rectifier, relay S3A is a seventh silicon-controlled rectifier, relay S3B is an eighth silicon-controlled rectifier, and relay S3B is a ninth silicon-controlled rectifier.

In a third embodiment, the relays may be insulated gate bipolar transistors (IGBT's) if the current is relatively high. As used here, a high current is in the thousands of amperes and volts. Of course, IGBT's are extremely versatile and can be used at any level of current and voltage. In this embodiment, relay S1A is a first insulated gate bipolar transistor, relay S1B is a second insulated gate bipolar transistor, relay S1C is a third insulated gate bipolar transistor, relay S2A is a fourth insulated gate bipolar transistor, relay S2B is a fifth insulated gate bipolar transistor, relay S2C is a sixth insulated gate bipolar transistor, relay S3A is a seventh insulated gate bipolar transistor, relay S3B is an eighth insulated gate bipolar transistor, and relay S3B is a ninth insulated gate bipolar transistor.

Unlike the SSR's, the SCR's and IGBT's may need a separate ‘firing’ card to turn them on and off. The nine switches may be connected three at a time to the three electrical phase wires from the power source and to the load. A different bank may be connected to the load every cycle or every ‘n’ cycles.

These three embodiments can be used in a variety of settings. The first setting is for end electricity users, such as an individual home or business. Individuals can reduce the electrical load one's home or business uses by more efficiently using the power provider. This provides two primary advantages: first, less electricity is consumed resulting in a smaller electricity bill; second, appliances do not suffer from phase vibration, as explained above resulting in longer lives for consumer and business electronics.

The second setting is for groups of end-users such as those receiving electrical power coming from a transformer or electrical power sub-station. In this case, the end users frequently receive different combinations of two phases of power and the distribution method is frequently more random than efficient. Having the disclosed invention in a transformer or electrical power sub-station avoids the power loss in inefficient random distribution of phases.

The third setting is for one for electrical power generators. In this case, the electrical power generator can produce less electricity; yet power the same number of consumers with the same needs by simply using the energy more efficiently. This applies to those using standard electrical generators and not motor-generators, since motor generators do not have load-balancing concerns.

That which is claimed:

1. A machine for switching current loads in a three phase power system, comprising,
an electrical system with a three phase power source and a three phase load;
a zero-cross detector electrically coupled to a timing mechanism;
the timing mechanism electrically coupled to a switching mechanism;
where the switching mechanism is electrically coupled to a first bank of switches, a second bank of switches, and a third bank of switches;
where a first power phase, a second power phase and a third power phase are electrically coupled to the first bank of switches, the second bank of switches, and the third bank of switches
where the first bank of switches, the second bank of switches, and the third bank of switches are electrically coupled to a first phase load, a second phase load and a third phase load such that one of the first bank of switches, the second bank of switches, and the third bank of switches can provide power to any the first phase load, the second phase load or the third phase load;
where the switching mechanism alternates which of the first power phase, the second power phase and the third power phase provides current to the first phase load, the second phase load or the third phase load.

2. The machine of claim 1, further comprising,
the zero-cross detector further comprises an opto isolater and an Insulated Gate Bipolar Transistor.

3. The machine of claim 1, further comprising,
the timing mechanism is a Johnson counter electrically coupled to a quad-NOR logic device.

4. The machine of claim 1, further comprising,
the switching mechanism further comprises a plurality of one shot multivibrators.

5. The machine of claim 1, further comprising,
the first bank of switches further comprise a first solid state relay a second solid state relay and a third solid state relay;
the second bank of switches further comprise a fourth solid state relay, a fifth solid state relay and a sixth solid state relay;
the third bank of switches further comprise a seventh solid state relay, an eighth solid state relay and a ninth.

6. The machine of claim 1, further comprising,
the first bank of switches further comprise a first silicon-controlled rectifier, a second silicon-controlled rectifier, and a third silicon-controlled rectifier;
the second bank of switches further comprise a fourth silicon-controlled rectifier, a fifth silicon-controlled rectifier, and a sixth silicon-controlled rectifier;
the third bank of switches further comprise a seventh silicon-controlled rectifier, an eighth silicon-controlled rectifier and a ninth silicon-controlled rectifier.

7. The machine of claim 1, further comprising
the first bank of switches further comprise a first insulated gate bipolar transistor, a second insulated gate bipolar transistor and a third insulated gate bipolar transistor;
the second bank of switches further comprise a fourth insulated gate bipolar transistor, a fifth insulated gate bipolar transistor and a sixth insulated gate bipolar transistor;
the third bank of switches further comprise a seventh insulated gate bipolar transistor; an eighth insulated gate bipolar transistor and a ninth insulated gate bipolar transistor.
